(19) United States
(12) Patent Application Publication
(10) Pub. No.: US 2012/0018135 A1
(43) Pub. Date: Jan. 26, 2012

(54) HEADER PLATE, A HEAT EXCHANGER, A METHOD OF MAKING A HEADER PLATE AND A METHOD OF MAKING A HEAT EXCHANGER

(75) Inventors: Mario Ciaffarafa, West Yorkshire (GB); Tristram Craig Palmer White, West Yorkshire (GB)

(73) Assignee: DENSO Marston Ltd., West Yorkshire (GB)

(21) Appl. No.: 12/839,450

(22) Filed: Jul. 20, 2010

(51) Int. Cl. F28F 9/02; B23P 15/26

(52) U.S. Cl. 165/173; 29/890.052

(57) ABSTRACT

A header plate for a heat exchanger, the header plate comprising a main part defining a plurality of slots to receive tubes, and the header plate including edges for attachment to a tank, the header plate being folded over onto itself at the said edges.

### FIELD

The invention relates to a header plate, a heat exchanger, a method of making a header plate and a method of making a heat exchanger.

### BACKGROUND

This section provides background information related to the present disclosure which is not necessarily prior art.

A known header plate for a heat exchanger, such as an inter-cooler, defines tube slots to receive tubes, and is arranged to be connected at its edge to a tank. The part of the header plate between the tube slots and the edge for connection to the tank can fail. In particular, pressure cycling can cause this area to flex repeatedly, leading to cracks appearing and consequent failure of the heat exchanger. Inter-coolers for example are operating at higher and higher charge temperatures which leads to thermally induced stresses. The entire header plate can be made from thicker gauge metal, but this increases the amount of metal used and hence the cost, as well as changing the requirement for the press to stamp out the header plate.

### SUMMARY

This section provides a general summary of the disclosure, and is not a comprehensive disclosure of its full scope or all of its features.

According to one aspect of the invention there is provided a header plate for a heat exchanger, the header plate comprising a main part defining a plurality of slots to receive tubes, and the header plate including edges for attachment to a tank, the edges being of greater thickness than the main part.

In this way, greater strength is provided in the area where it is needed.

The edges may be any desired thickness and in a preferred embodiment are twice the thickness of the main part.

According to another aspect of the invention there is provided a header plate for a heat exchanger, the header plate comprising a main part defining a plurality of slots to receive tubes, and the header plate including edges for attachment to a tank, the header plate being folded over onto itself at the said edges so that the end of the header plate lies adjacent a slot.

In this way, the edges are twice the thickness of the remainder of the header plate, and so greater strength is provided in the area where it is needed, but the amount of material used and hence the cost is not increased substantially.

The said edges of the header plate may be folded over so that the end of the header plate lies adjacent a slot.

The header plate may define a lip around each slot. Preferably, the end of the edge of the header plate is attached to the lip of an adjacent slot. In this way the full distance between the connection to the tank and the adjacent slot is reinforced.

In one embodiment, each lip extends upwardly, towards the tank and the edge may then be folded inwardly, and the end of the edge may be attached to the lip. In a preferred embodiment, each lip extends downwardly, away from the tank. This improves the stiffness of the header plate. The edge may then be folded outwardly and the end of the edge may be attached to the lip.

The edge may be folded to leave a series of projecting tabs which can be crimped over to secure the tank.

According to another aspect of the invention there is provided a heat exchanger comprising a plurality of tubes, a tank and a header plate according to the first aspect of the invention, the tubes being received in the slots in the header plate and the tank being attached to the edges of the header plate.

The heat exchanger may be an inter cooler, an exhaust gas recirculation cooler, or an automotive radiator.

Where the header plate has tabs, the tank preferably has a foot and the tabs are crimped over the foot to hold the tank in place.

According to a further aspect of the invention there is provided a method of making a header plate including the step of bending over the edge of the header plate onto itself so that the end of the header plate lies adjacent a slot defined in the header plate.

The bending step may be carried out as a separate operation or as part of the step of press forming the header plate.

The method may further include the step of attaching the end of the edge of the header plate to another part of the header plate, which is preferably a lip defining a slot to receive a tube.

The method may further comprise the step of, before bending over the edge of the header plate, making a series of cut lines in the header plate, for example by cutting or pressing out, each cut line extending from the intended fold line towards the outer end of the header plate and back to the intended fold line to define a tab. Folding along the fold line in the subsequent step will leave the ‘tabs projecting out.

The method may be a method of making a header plate according to the first aspect of the invention.

According to another aspect of the invention there is provided a method of attaching a header plate to a tank for a heat exchanger, the tank including a tank foot and the header plate being made according to the previous aspect of the invention and including tabs, the method including the step of crimping over the tabs onto the tank foot.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Embodiments of the invention will now be described by way of example and with reference to the accompanying drawings, in which:

FIG. 1 is an end elevation in cross section of the heat exchanger in a first embodiment of the invention;

FIG. 2a is a fragmentary detail view of part of the heat exchanger of FIG. 1;

FIG. 2b is the view of FIG. 1a in a second embodiment;

FIG. 2c is the view of FIG. 1a in a third embodiment;

FIG. 3 is a perspective view from below of header plate in a fourth embodiment;

FIG. 4a shows the flat blank,

FIG. 4b shows the partially folded blank,

FIG. 4c shows the blank with the fold completed;

FIG. 5a is a fragmentary detail perspective view of the header plate of FIG. 4 bent to shape to receive a tank foot;

FIG. 5b is the view of FIG. 5a with the tank foot in place and the tabs of the header plate crimped over; and,

FIG. 6 is a fragmentary detail elevation in cross-section of the view of FIG. 5b.

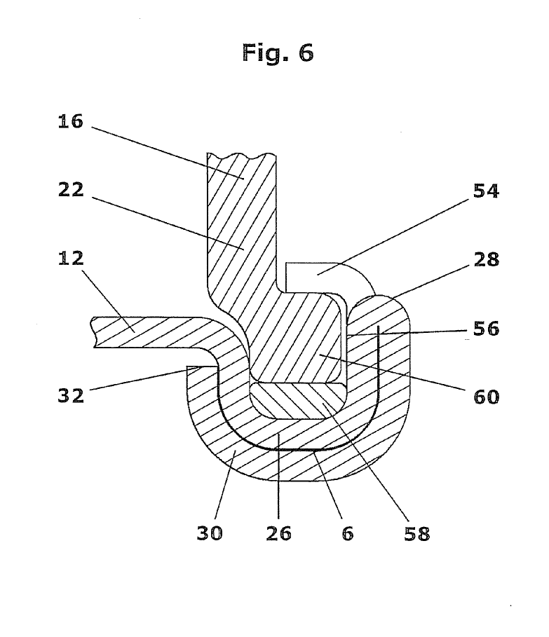

Corresponding reference numerals indicate corresponding parts throughout the several views of the drawings.

### DETAILED DESCRIPTION

Example embodiments will now be described more fully with reference to the accompanying drawings.

The heat exchanger of the first embodiment is a tube type charge air cooler, in particular an inter cooler, and comprises a header plate 12, a plurality of tubes 14 and a tank 16.

The header plate 12 is generally tray shaped and defines two rows of slots 18 along its length to receive the tubes 14. The slots 18 are formed by drawing to result in an upwardly extending lip 20 surrounding and defining each slot 18. This increases the area of contact with the tubes 14, as well as increasing the stiffness of the header plate. The header plate 12 is made of aluminum.

The tank 16 is in the form of a downwardly open container with downwardly extending side walls 22.

The header plate 12 comprises a main part 8 and edges 24. The edges 24 of the header plate 12 are folded over onto themselves. In this way a double thickness hem 6 is formed. Thus, the edge 24 comprises a first part 26 extending from the outer edge of one slot 18 to the fold 28, and a second part 30 extending from the fold 28 to the end 32 of the header plate 12. In this embodiment the end 32 lies adjacent the lip 20 of the slot 18. The edge 24 of the header plate 12 is bent upwards. The depending side walls 22 of the tank 16 are received within the edges 24 of the header plate 12 and a connection 34 between the tank wall 22 and the header plate 12 is formed in the region of the fold 28. The connection 34 may be formed by welding.

In use, the double thickness of metal in the header plate 12 between the outer edge of the lip 20 of the slot 18 and the connection 34 to the tank 10 strengthens this area against failure as a result of thermal and pressure cycling. The durability of the header plate 12 is thus increased so that failures due to split header plates are less likely to occur.

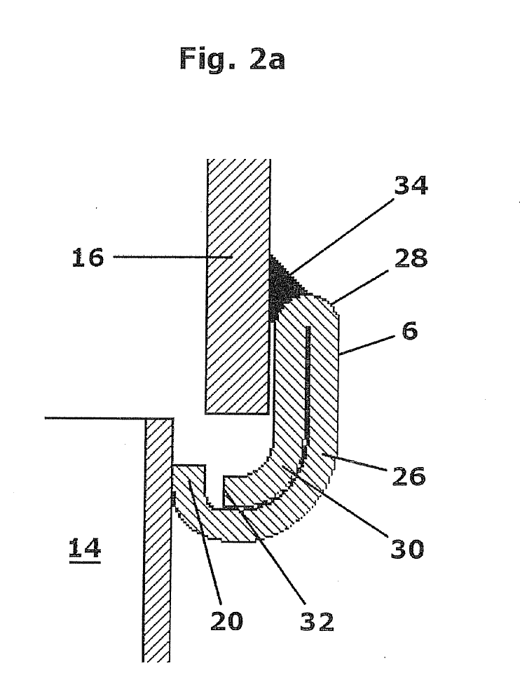

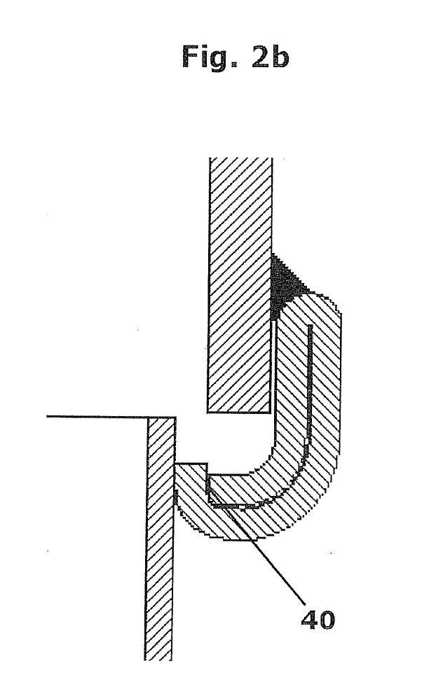

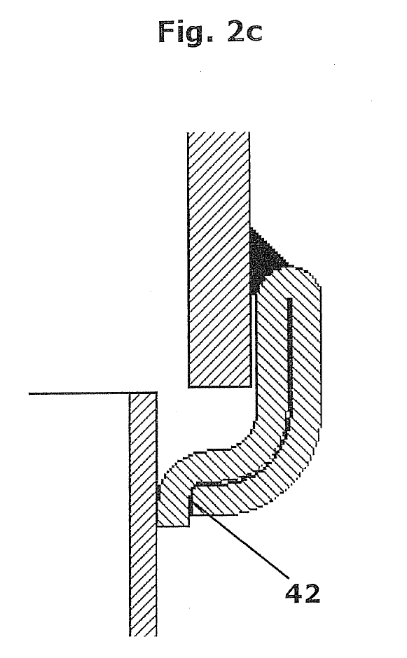

FIG. 2b shows a second embodiment which is similar to the first embodiment. The same reference numerals will be used for equivalent features. The only difference from the first embodiment is that the end 32 of the header plate 12 is joined on to the lip 20 at 40. This ensures that the entire distance between the connection 34 to the tank and the connection 40 to the slot lip 20 is reinforced. The join 40 may be a brazed joint.

FIG. 2c shows a third embodiment which is similar to the embodiment of FIG. 2b. Only the differences from that embodiment will be described.

In this embodiment, instead of the edge 24 of the header plate 12 being folded inwards on top of itself, the edge is folded downwardly away from the tank 16 to lie underneath. Also, the lips 20 defining the slots 18 extend downwardly away from the tank 16 rather than upwardly as in the first and second embodiments. Like the second embodiment, the end 32 of the header plate 12 is attached to the adjacent lip 20 at 42, for example, by brazing. Inverting the lips 20 defining the slots 18 to point towards the core rather than the tank 16 increases the stiffness of the header plate 12.

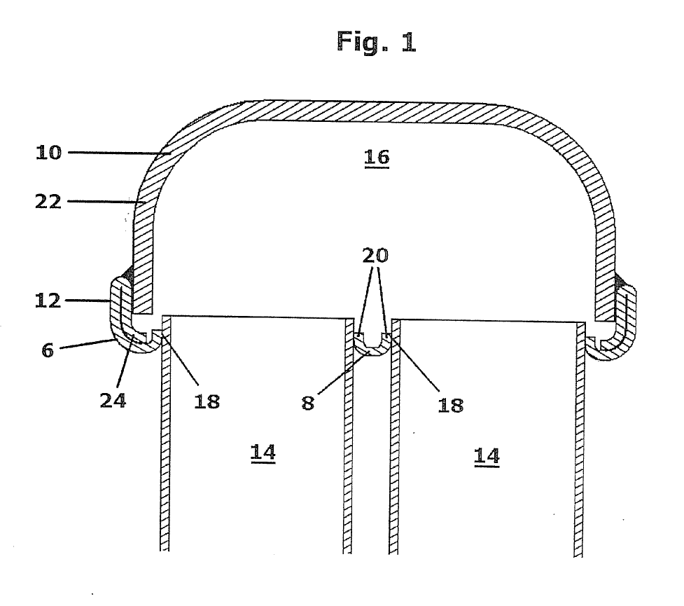

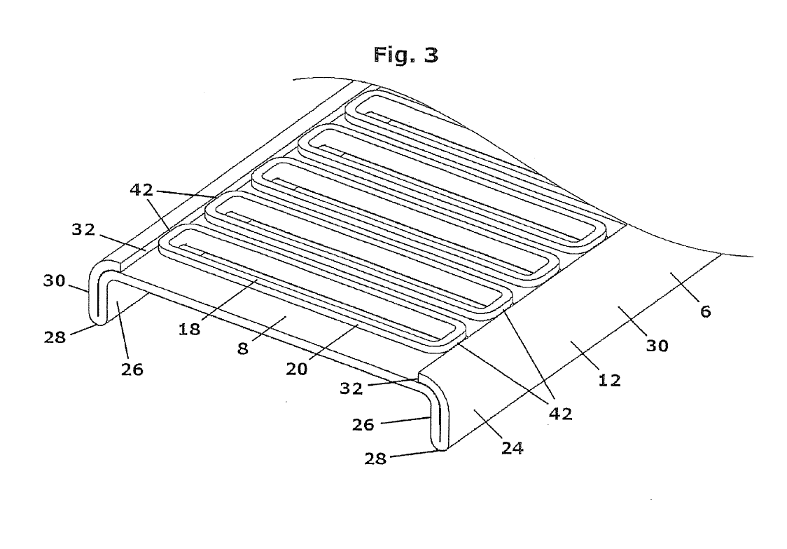

FIG. 3 shows a further embodiment which is similar to the embodiment of FIG. 2c. The same reference numerals will be used for equivalent features. Only the differences from the embodiment of FIG. 2c will be described. The only difference between the header plate of FIG. 3 and the header plate of FIG. 2c is that in the header plate of FIG. 3 there is only a single row of slots 18 rather than the double row in the embodiments of FIGS. 1 and 2.

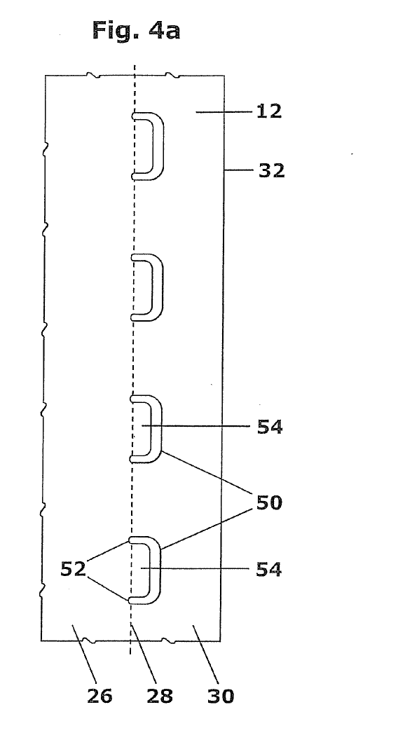

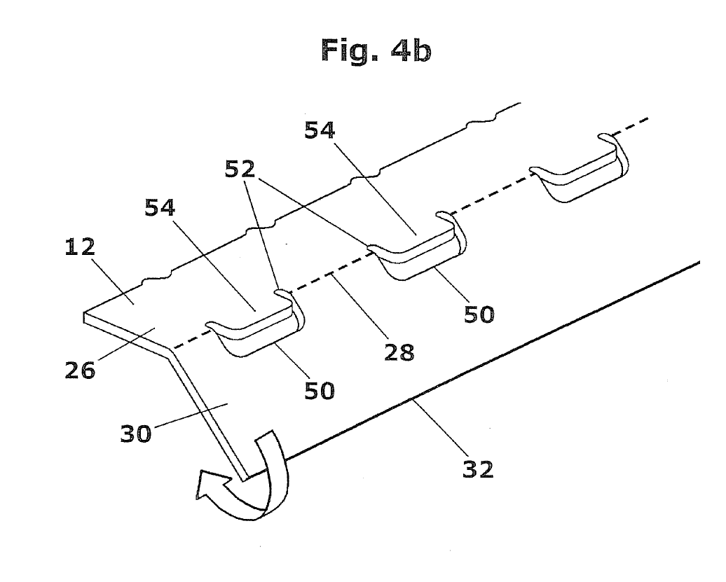

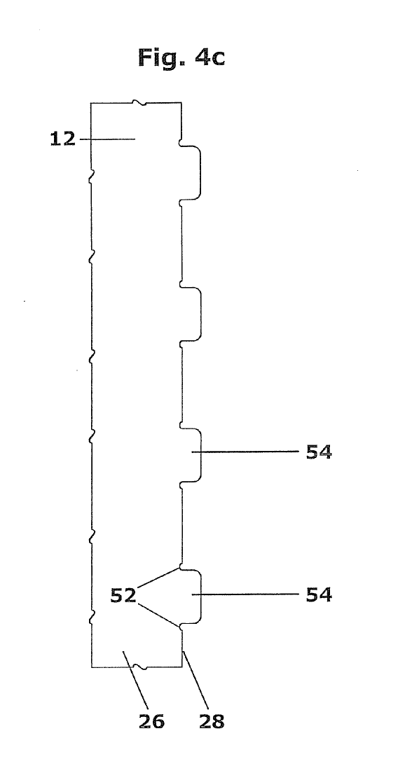

FIGS. 4a-4c show the edge of a blank for forming the header plate 12 in a further embodiment. The header plate 12 of this embodiment is suitable for an automotive radiator. The embodiment is similar to the embodiment of FIG. 2c and only the differences from that embodiment will be described. The same reference numerals will be used for equivalent features.

A series of C shaped cuts 50 are made in the outer part 30 of the edge 24 of the header plate 12 so that the ends 52 of the arms of the C shaped cuts 50 intersect the notional line which is to form the fold line 28. As shown in FIG. 4b, upon folding about the fold line 28, the metal 54 within each cut 50 remains unfolded while the outer part 30 of the header plate 12 is folded about the fold line 28. As shown in FIG. 4c, once the edge 24 of the header plate 12 has been folded completely round onto itself, the metal 54 which lay within the cuts 50 forms tabs 54.

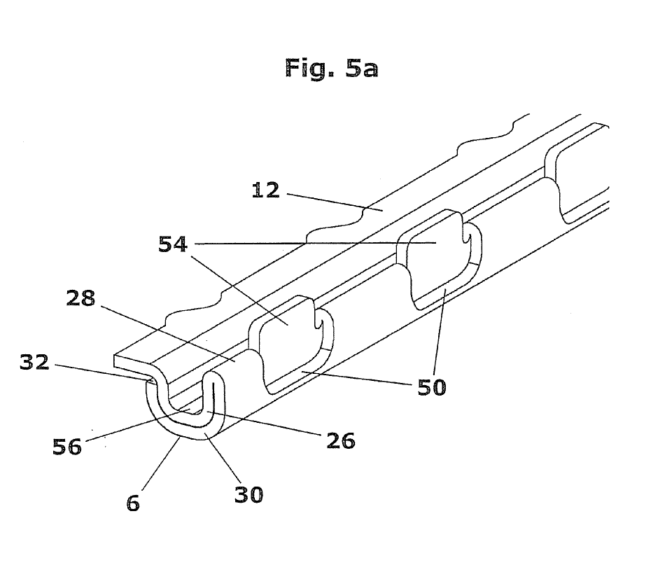

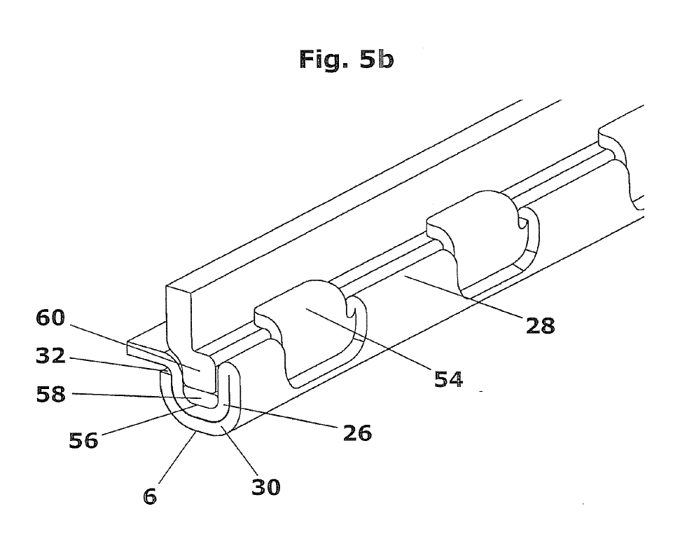

FIG. 5a shows the edge of the header plate 12 bent to shape. Thus, the edge 24 has been bent to form a trough 56 facing upwardly, with the tabs 54 pointing upwards.

FIG. 5b shows the same view with a gasket 58 on the floor of the trough 56, and the tank foot 60 inserted into the trough 56. The tabs 54 have been crimped over to secure the tank foot 60 in the trough 56.

It will be seen that the double thickness resulting from folding over of the edge of the header plate 12 provides extra strength around the gasket 58 and tank foot 60. The tabs 54 hold the tank 16 in position.

The automotive radiator of this embodiment may have more than two rows of slots, and may have, for example, six slots.

Various modifications to the specific embodiments will be apparent to the person skilled in the art.

Thus the C shaped cuts 50 could be dove tail shaped or rectangular, for example.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A header plate for a heat exchanger, the header plate comprising a main part defining a plurality of slots to receive tubes, and the header plate including edges for attachment to a tank, the edges being of greater thickness than the main part.

2. A header plate as claimed in claim 1, wherein the edges are twice the thickness of the main part.

3. A header plate for a heat exchanger, the header plate comprising a main part defining a plurality of slots to receive tubes, and the header plate including edges for attachment to a tank, the header plate being folded over onto itself at the said edges.

4. A header plate as claimed in claim 3, wherein the said edges of the header plate are folded over so that the end of the header plate lies adjacent a slot.

5. A header plate as claimed in claim 3, wherein the header plate defines a lip around each slot.

6. A header plate as claimed in claim 5, wherein the end of the edge of the header plate is attached to the lip of an adjacent slot.

7. A header plate as claimed in claim 5, wherein each lip extends towards the tank.

8. A header plate as claimed in claim 5, wherein each lip extends away from the tank.

9. A header plate as claimed in claim 3, wherein the edge is folded to leave a series of projecting tabs which can be crimped over to secure the tank.

10. A heat exchanger comprising a plurality of tubes, a tank and a header plate according to claim 1, the tubes being received in the slots in the header plate and the tank being attached to the edges of the header plate.

11. A heat exchanger as claimed in claim 10, wherein the heat exchanger is an inter cooler, an exhaust gas recirculation cooler, or an automotive radiator.

12. A heat exchanger as claimed in claim 10, wherein, where the header plate has tabs, the tank has a foot and the tabs are crimped over the foot to hold the tank in place.

13. A method of making a header plate including the step of bending over an edge of the header plate onto itself.

14. A method as claimed in claim 13, wherein the bending step is carried out as part of a step of press forming the header plate.

15. A method as claimed in claim 13, wherein the method further includes the step of attaching the end of the edge of the header plate to another part of the header plate.

16. A method as claimed in claim 15, wherein, the method further includes the step of attaching the end of the edge of the header plate to a lip of the header plate, the lip defining a slot to receive a tube.

17. A method as claimed in claim 13 of making a header plate as claimed in claim 1.

18. A method as claimed in claim 13, wherein the method further comprises the step of, before bending over the edge of the header plate, making a series of cut lines in the header plate, each cut line extending from the intended fold line towards the outer end of the header plate and back to the intended fold line to define a tab.

19. A method of making a header plate and attaching it to a tank, the tank including a tank foot, the method comprising the method of claim 18 and the step of crimping over the tabs onto the tank foot.
